(19) United States
(12) Patent Application Publication
(10) Pub. No.: US 2013/0067414 A1
(43) Pub. Date: Mar. 14, 2013

(54) SELECTING AND EXECUTING OBJECTS WITH A SINGLE ACTIVATION

(71) Applicants: Jan-Kristian Markiewicz, Redmond, WA (US); Gerrit Hendrik Hofmeester, Woodinville, WA (US); Jon Gabriel Clapper, Seattle, WA (US); Jennifer Nan, Seattle, WA (US); Jesse Clay Satterfield, Seattle, WA (US)

(72) Inventors: Jan-Kristian Markiewicz, Redmond, WA (US); Gerrit Hendrik Hofmeester, Woodinville, WA (US); Jon Gabriel Clapper, Seattle, WA (US); Jennifer Nan, Seattle, WA (US); Jesse Clay Satterfield, Seattle, WA (US)

(73) Assignee: MICROSOFT CORPORATION, Redmond, WA (US)

(21) Appl. No.: 13/230,685

(22) Filed: Sep. 12, 2011

(51) Int. Cl. G06F 3/048

(52) U.S. Cl. 715/835

(57) ABSTRACT

Techniques of handling input from a pointing device within a computing system. The method includes, under control of one or more processors configured with executable instructions, receiving from the pointing device a first signal while the pointing device is pointing at an object related to an executable application. The origin of the first signal is determined and if the first signal originated based upon a single activation of a first user input on the pointing device, the object is selected. If the first signal originated based upon a single activation of a second user input on the pointing device, the object is executed.

### BACKGROUND

In computing systems, it is generally useful to provide a method to execute an object on a visual display in order to launch an application associated with the object. It is also generally useful to provide a method in order to select the object. With a typical desktop computer graphical user interface, a single click of an input with a pointing device, generally in the form of a mouse, will highlight an object while the pointer or cursor of the pointing device is pointing at the object. The input is usually the right input button of the mouse. A double click of an input (usually the left input button of a mouse) of the pointing device generally will execute the object while the pointer of the pointing device is pointing at the object. However, with computing systems that include a touch screen visual display, it is generally desirable to utilize a single tap on the object on the visual display in order to launch the application associated with the object. However, when translating this type of interaction to pointing device usage (single-click launches) within a computing system, the ability to select or highlight objects is lost.

Certain computing systems may display an on-object user interface, such as a checkmark, on each object. Clicking on the object itself will execute the object, but clicking on the checkmark while the pointing device's pointer is pointing at the checkmark will select the object. These checkmarks can either be visible on all objects all the time or only shown for an object that currently has the pointing device's pointer pointing at the object.

In certain arrangements, a mode-change button can be provided on the pointing device. For example, pushing a “selection-mode” user interface button can trigger a mode change. A single-click of some type of button on the pointing device then selects an object instead of executing the object at which the pointing device pointer is pointing.

In other arrangements, some sort of modifier key could be utilized. For example, holding down the shift key on a keyboard could make a single-click of an input button on the pointing device select an object at which the pointing device pointer is pointing instead of executing the object.

### SUMMARY

This summary introduces concepts for a pointing device configured for selection and execution of objects utilizing single activation of separate inputs on the pointing device. The concepts are further described below in the detailed description. This summary is not intended to identify essential features of the claimed subject matter, nor is it intended for use in limiting the scope of the claimed subject matter.

This disclosure describes examples of embodiments for handling input from a pointing device within a computing system. In one embodiment, a signal related to an object executable within the computing system is received from the pointing device. The pointing device is causing a pointer to point at the object on a visual display of the computing system. An origin of the signal is determined with respect to the pointing device. Based upon determining the origin of the signal, if the signal originated based upon a single activation of a first user input of the pointing device, then the object is selected. If on the other hand, the signal originated based upon a single activation of a second user input of the pointing device, the object is executed.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example computing system usable to implement a pointing device for selecting and executing objects in the computing system with a single activation of user inputs on the pointing device.

FIG. 2 illustrates an example pointing device for selecting and executing objects in the computing system with a single activation of user inputs on the pointing device.

FIG. 3 illustrates an example of a screen shot on a visual display, where the screen shot includes objects for selecting and executing using the pointing device.

FIG. 4 illustrates an example of the screen shot of FIG. 3, where an object has been selected using the pointing device.

FIG. 5 illustrates an example of using the pointing device to select, unselect and execute objects within the computing system using the pointing device.

FIG. 6 illustrates an example method of handling input from a pointing device within the computing system of FIG. 1.

FIG. 7 illustrates an example of a screen shot on a visual display, where the screen shot illustrates a document from the Internet displayed using a web browser.

FIG. 8 illustrates an example of the screen shot of FIG. 7, where the menu of commands is being displayed after selecting such display with the pointing device.

### DETAILED DESCRIPTION

### Overview

As previously noted, existing technologies often fail to accurately and adaptively allow for user interaction within computing systems where users can launch an object with a single tap on a touch screen. When the user input shifts from the touch screen to a pointing device, such as a mouse, the ability to select an object as opposed to launching the object is lost.

The present disclosure describes techniques that allow for selecting an object with a single activation of a first user input on a pointing device and executing an object based upon a single activation of a second user input of the pointing device.

Generally, a user of a computing system will use an input device to select and execute objects displayed on a visual display of the computing system. As is known, the objects represent, for example, software applications that can be executed within the computing system, web addresses on the internet, operations that can be performed within the computing system, etc. One such input device is a pointing device such as, a mouse. As is known, the mouse generally includes at least two user inputs in the form of a right button and a left button. The right and left buttons are generally located on the top of the mouse. The mouse can also include other user inputs, often in the form of buttons. Such additional input buttons are often located along a side of the mouse. Additionally, a mouse might also include a roller ball or a scroll wheel located on the top of the mouse between the right button and the left button. As used herein, execution of an object refers to execution of a primary command of, for example, a software application, an executable file, an application program, an application platform, a web address, an operation, etc. that the object represents. Thus, general use of the term application refers to, for example, a software application, an executable file, an application program, an application platform, a web address, an operation, etc.

In an embodiment, the user moves the mouse over a surface and based upon the movement of the mouse, a pointer or cursor is displayed on the visual display of the computing system. If the user wishes to select or execute an object, the user moves the mouse such that the pointer points at the user's desired object. If the user wishes to select or execute an object, the user moves the mouse such that the pointer points at (i.e., hovers over) the user's desired object. If the user wishes to select the object, then the user performs a single activation of a user input on the mouse while the pointer is pointing at the object. For example, a single click of the right button will select the object and the object can be highlighted. Additionally, or instead, a menu of commands can appear on the visual display adjacent to the selected object, wherein this menu of commands is associated with the selected object. The user can continue to move the mouse and select other objects by pointing at the additional objects. Thus, multiple objects can be selected at a time.

Additionally, if a user wishes to execute an object, then the user can move the mouse such that the pointer points at a desired object. When the pointer is pointing at the object, then the user can execute or launch the object with a single activation of a second user input on the pointing device. For example, a single click of the left button will launch the desired object, whether or not the desired object was previously selected or not. Upon executing the object, any objects that have been previously selected and are still selected would then be unselected. However, if desired, the other selected objects can remain selected.

In addition, if an application is currently being executed or operated within the computing system such as, an internet web browser, then an operating system of the computing system can be configured such that the web browser does not display any commands for execution for the web browser. If the user moves the mouse such that the pointer points at the web browser, then a single activation of a user input, such as, the right button, will cause a menu of commands to appear. The user can then use the mouse to activate various commands within the menu of commands by pointing the pointer at desired commands and activating some of the inputs on the pointing device. If the user wishes to discontinue using the web browser, then the user can move the pointer so that it is not pointing anywhere at the web browser on the visual display. With a single activation of a user input on the pointing device, such as, for example, a single click of the left button, then the web browser is terminated. If the user wishes to have the menu of commands disappear from display, then a single activation of the first user input, i.e., a single click of the right button, causes the menu of commands to disappear. Additionally, if none of the commands has been used for a certain amount of time, then the display of the menu of commands can “time-out” and thus, the menu of commands will no longer be displayed.

### Example Architecture

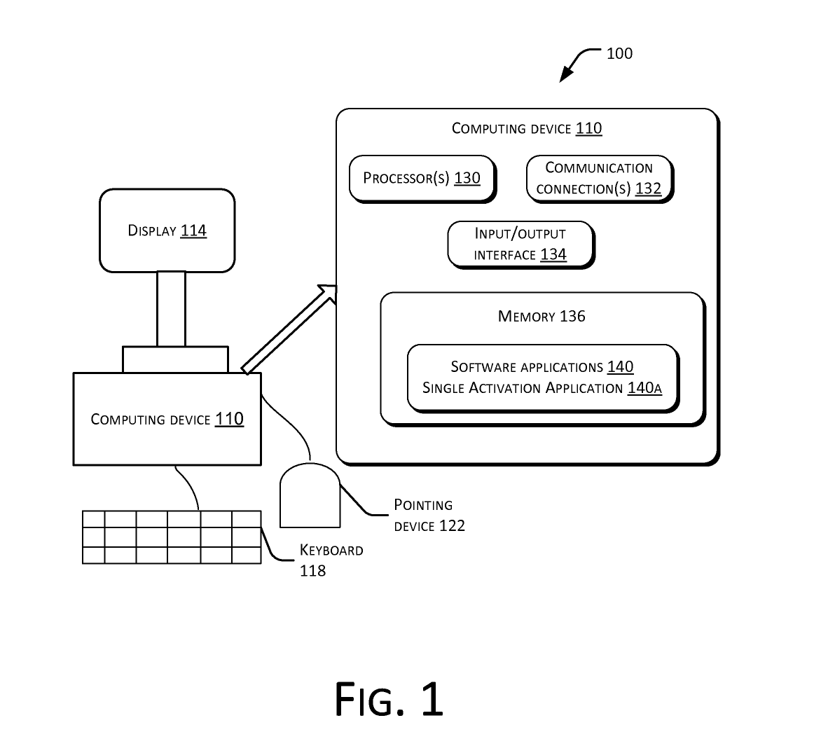

FIG. 1 illustrates an example of a computing system 100. The computing system 100 includes a computing device 110. In the illustrated example of FIG. 1, the computing system 100 further includes a visual display 114, a first input mechanism 118 in the form of a keyboard, and a second input mechanism 122 in the form of a pointing device, i.e., a mouse. The computing device 110 can be in the form of a single unit, often referred to as a desktop unit, which can be configured to sit on a desktop or can be configured to sit on the floor. Additionally, the computing system 100 can be in the form of, for example, a laptop computer, a notebook or portable computer, a handheld device, a netbook, an Internet appliance, a portable reading device, an electronic book reader device, a tablet or slate computer, a game console, a mobile device (e.g., a mobile phone, a personal digital assistant, a smart phone, etc.), a media player, etc. or a combination thereof. Such computing devices generally combine some or all of the elements of the computing system into a single device. For example, a laptop computer includes a visual display, a keyboard, and often a touchpad that functions as a mouse. Additionally, a toggle stick that functions in a manner similar to a roller ball can be included within the laptop computer's keyboard.

The computing device 110 includes one or more processors 130 coupled to a memory 136. The computing device 110 may further include one or more communication connection(s) 132 and one or more input/output interfaces 134. The communication connection(s) 132 allow the computing device 110 to communicate with other computing devices over wired and/or wireless networks and may include, for example, wide area, local area, and/or personal area network connections. For example, the communication connection(s) 132 may include cellular network connection components, WiFi network connection components, Ethernet network connection components, or the like. The input/output interfaces 134 include, for the example of FIG. 1, a display, a keyboard and a mouse. The input/output interfaces 134 can further include, depending upon the type of computing device 114, a touch pad, a roller ball, a scroll wheel, an image capture device, an audio input device, an audio output device, and/or any other input or output devices.

The memory 136 is an example of computer-readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The memory 136 includes one or more software applications 140. As an example, the software applications 140 generally include an operating system (e.g., Windows® operating system, Mac® operating system, or the like), one or more platform software (e.g., Java®), and/or various application programs (e.g., a web browser, an email client, a word processing application, a spreadsheet application, a voice recording application, a calendaring application, a news application, a text messaging client, a media player application, a photo album application, an address book application, a weather application, a viewfinder application, a social networking application, a game, and/or the like). The software applications 140 also include a single activation application 140A. The single activation application 140A may be separate or may be included with another software application such as, for example, the operating system. The single activation application 140A allows for the pointing device 122 to select and execute objects based upon single activation of first and second user inputs of the pointing device, as will be described further herein.

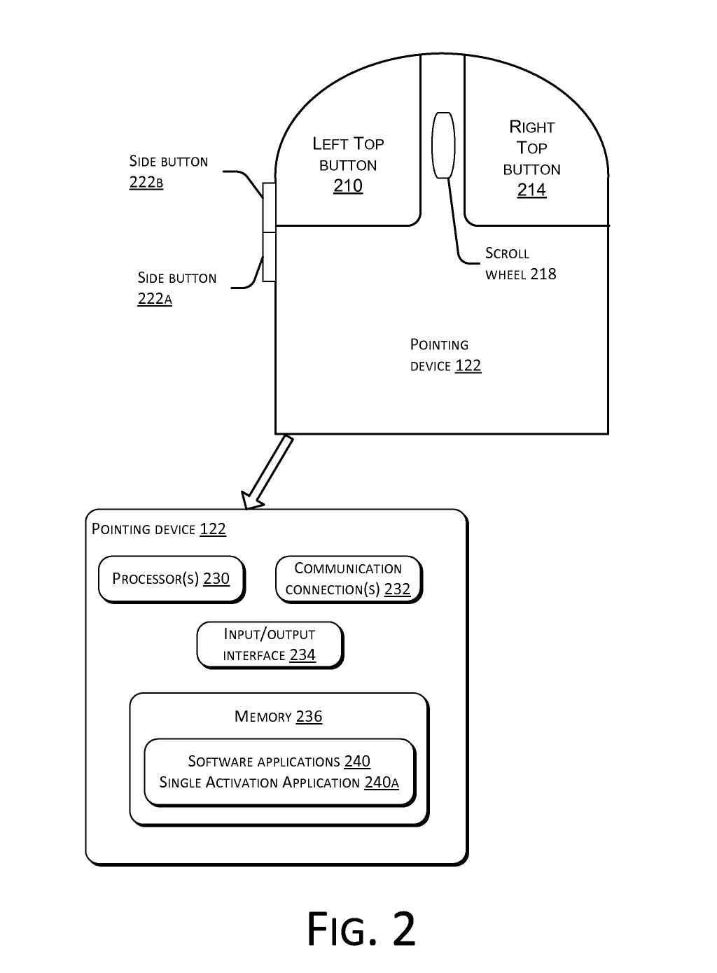

With reference to FIG. 2, the pointing device 122 includes several user inputs in the form of a left top button 210, a right top button 214 and two side buttons 222A, 222B. The pointing device 122 also includes another user input in the form of a scroll wheel 218. Thus, the example of pointing device 122 illustrated in FIG. 2 is what is commonly referred to as a mouse. The pointing device 122 can include more or fewer user inputs. Additionally, the types of user inputs may be different. For example, instead of a scroll wheel 218, a roller ball (not illustrated) may be included. The pointing device 122 generally includes one or more processors 230 coupled to memory 236. The memory 236 includes one or more software applications 240 and other program data. One of the software applications 240 included within the memory 236 is an operating system for the pointing device 122 that is utilized by the one or more processors to control operation of the pointing device and to allow the pointing device 122 to be configured for operation with the computing system 100. Thus, the one or more processors 230 serve as a controller for the pointing device 122. The software applications 240 may also include a single activation application 240A. The single activation application 240A may be separate or may be included with another software application such as, for example, the operating system for the pointing device 122. The single activation application 240A allows for the pointing device 122 to select and execute objects based upon single activation of first and second user inputs of the pointing device, for example the right top button 214 and the left top button 210, as will be described further herein. The single activation application 240A may or may not be needed based upon the configuration of the single activation application 140A. Additionally, one of the software applications 140 in the memory 136 of the computing device 110 is a device driver for the pointing device.

### Example Methods

In general, when using the computing system 100, a user generally selects an application 140 to be executed within the computing system 100. When a computing system's operating system is Windows® by Microsoft®, a desktop or other interface displays numerous objects in the form of icons that represent applications for execution within the computing system 100.

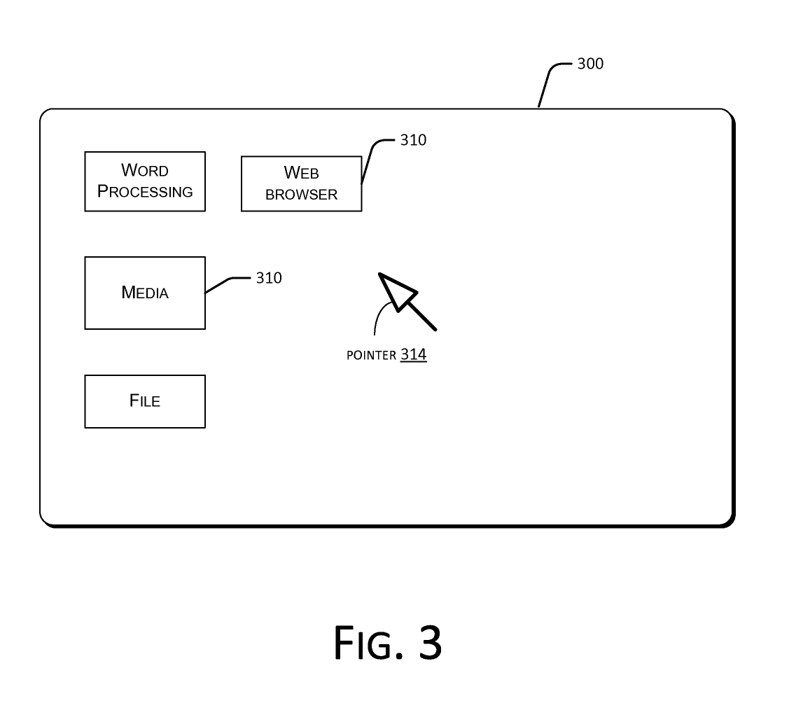

FIG. 3 illustrates an example of a desktop image 300 that includes multiple objects 310 for possible selection and/or execution. Additionally, as is known, objects can be displayed within various applications while the application is being executed. For example, when executing a media player within the computing system 100, objects representing songs, albums, videos, etc. may be displayed. Selection and/or execution of such objects can lead to various operations such as, for example, playing a song, copying a song, deleting a song, etc.

The objects 310 can be selected and executed by using the pointing device 122 to point a pointer 314 at a desired object and performing a single activation of an appropriate user input on the pointing device 122. Generally, by using the pointing device 122 to point at the object, a user can select the object by a single activation of a first user input of the pointing device, i.e., a single click of the first user input. In an embodiment, the right top input button 214 of the pointing device 122 serves as the first user input. The single activation of the right top button 214 provides a signal from the pointing device 122 to the computing device 110. The signal can be handled by the operating system of the computing device 110 to determine the origin of the signal, i.e., to determine that the signal was created by a single activation of the right top input button 214 of the pointing device 122.

Generally, when an object is selected, the object is “highlighted.” That is, the single activation application 140A may display a border around the object, change a color or shading of the object, or otherwise visually indicate that the object is currently being selected. Additionally, a menu 318 of commands for possible execution with respect to the object may appear on the visual display 114 adjacent to the object. The displaying of the menu 318 can be in addition to or in lieu of highlighting the object.

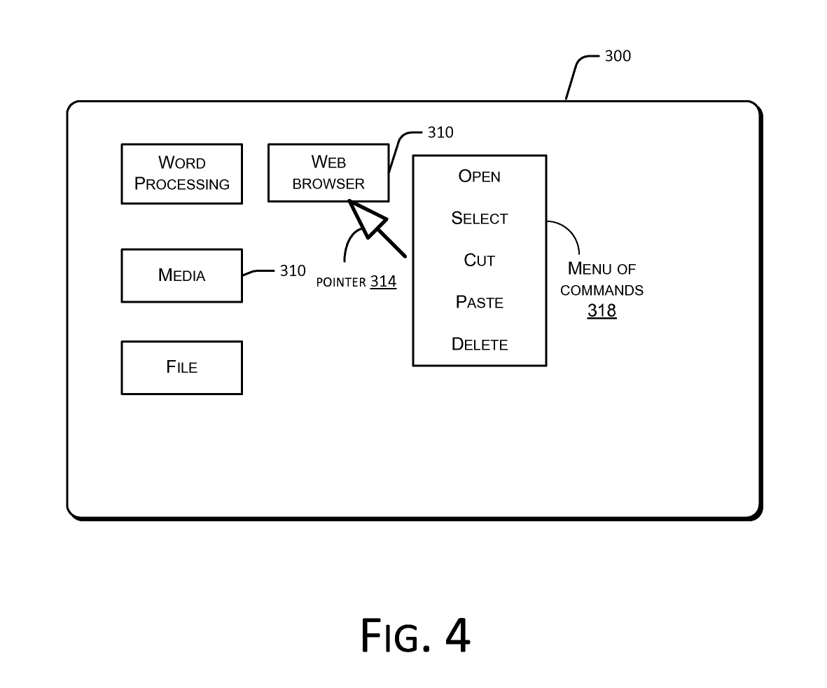

FIG. 4 illustrates an example of an object after it has been selected. The commands can be executed by pointing at a desired command for execution with the pointing device 122 by moving the pointing device 122, and thereby the pointer 314 such that the pointer points at the desired command. The command is executed by a single activation of a user input such as, for example, a single click on the left input button 210.

If the user wishes to unselect an object 310, the user simply moves the pointing device 122 so that the pointer 314 points at the selected object 310. With a single activation of the first user input, i.e., the right top input button 214, the object is unselected. Additionally, in accordance with various embodiments, multiple objects can be selected simultaneously. In other words, a user can select a first object and then select a second object. The first object will remain in a selected state until the user unselects the first object or until an object is executed, as will be described further herein.

In accordance with various embodiments of the present disclosure, an object 310 is executed by moving the pointing device 122 such that the pointer 314 points at an object. A single activation of a second user input on the pointing device, i.e., a single click of the left top input button 210, launches or executes the primary command for object 310 at which the pointer 314 is pointing. A primary command is usually a command that cause the object to open and begin operation. A primary command can, however, be something different depending upon the application represented by the object 310. The single activation of the left top button 210 provides a signal from the pointing device 122 to the computing device 110. The signal can be handled by the operating system of the computing device 110 to determine the origin of the signal, i.e., that the signal was created by a single activation of the left top input button 210 of the pointing device 122.

If the user executes an object 310 and other objects are currently selected, then the execution of the object 310 will unselect the other selected objects. However, if desired, the other selected objects can remain selected such that when the executed object stops being executed, then the other objects remain selected. An object does not need to be, but can be, in a selected state prior to being executed.

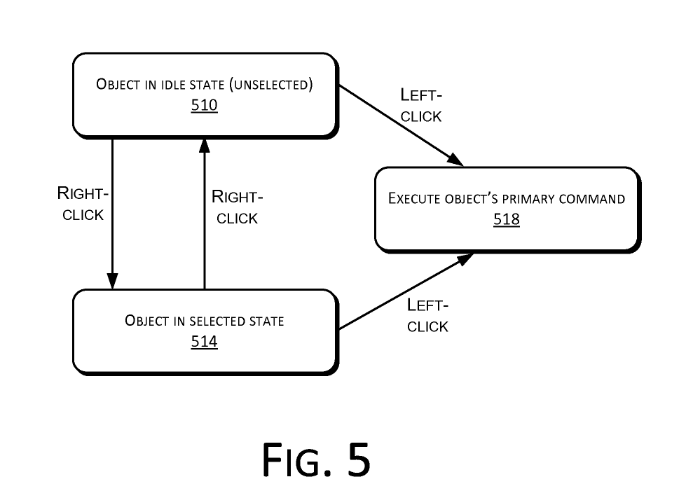

Thus, with reference to FIG. 5, the present disclosure provides for the ability of a single activation of a first user input (e.g., right click the right top button 214) on the pointing device 122 to select an object 310 at which the pointing device 122 is pointing a pointer 314, and move the object from an idle state (unselected) 510 to a selected state 514. A subsequent activation of the first user input (e.g., right click the right top button 214) while the pointing device 122 is pointing its pointer 314 at the object 310 in a selected state causes the object to be unselected. In other words, the object 310 moves from the selected state 514 back to an idle state (unselected) 510. Thus, one can toggle an object 310 between being selected and unselected by repeatedly clicking the first user input on the pointing device 122. Likewise, multiple objects 310 can be selected and remain selected simultaneously. Additionally, a single activation of a second user input (e.g., left click the left top button 210) on the pointing device 122 causes the object 310 move from either an idle state (unselected) 510 or a selected state 514 to an “execution” state where the object's primary command is executed.

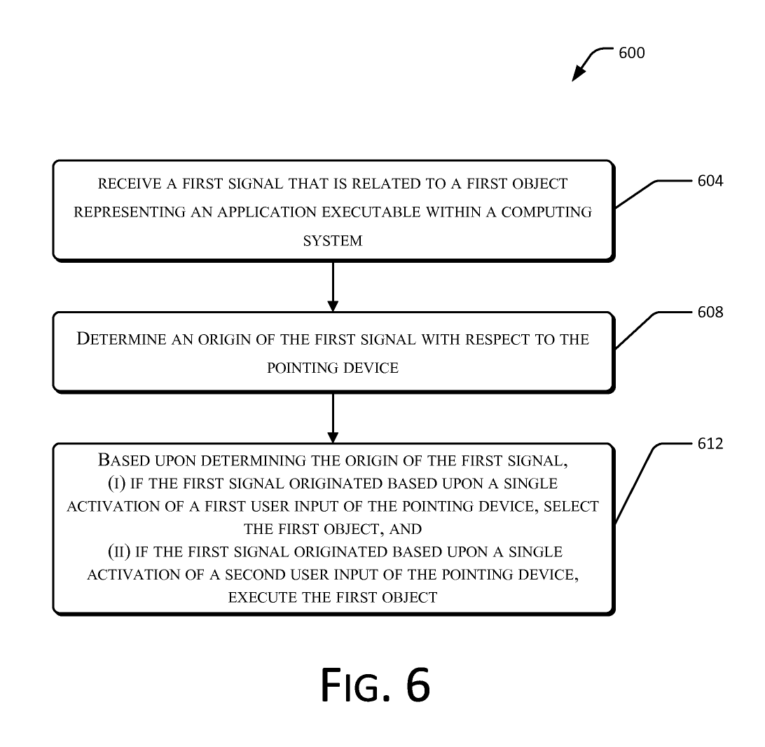

In particular, in accordance with various embodiments and with reference to FIG. 6, a method 600 of handling input from a pointing device 122 within a computing system is described. This method, as well as any other methods described herein, may be illustrated as a collection of acts in a logical flow graph. The logical flow graph represents a sequence of operations that can be implemented in hardware, software, or a combination thereof. In the context of software, the blocks represent computer instructions stored on one or more computer-readable media that, when executed by one or more processors, perform the recited operations. Note that the order in which the process is described is not intended to be construed as a limitation, and any number of the described acts can be combined in any order to implement the process, or an alternate process. Additionally, individual blocks may be deleted from the process without departing from the spirit and scope of the subject matter described herein

The method 600 includes, at 604, receive a first signal from the pointing device, the first signal being related to a first object representing an application executable within the computing system. The pointing device is causing a pointer to point at the first object on a visual display of the computing system. At 608, determine an origin of the first signal with respect to the pointing device. At 612, based upon determining the origin of the first signal, if the first signal originated based upon a single activation of a first user input of the pointing device, select the first object. However, if the first signal originated based upon a single activation of a second user input of the pointing device, execute the first object.

### Alternative Embodiments

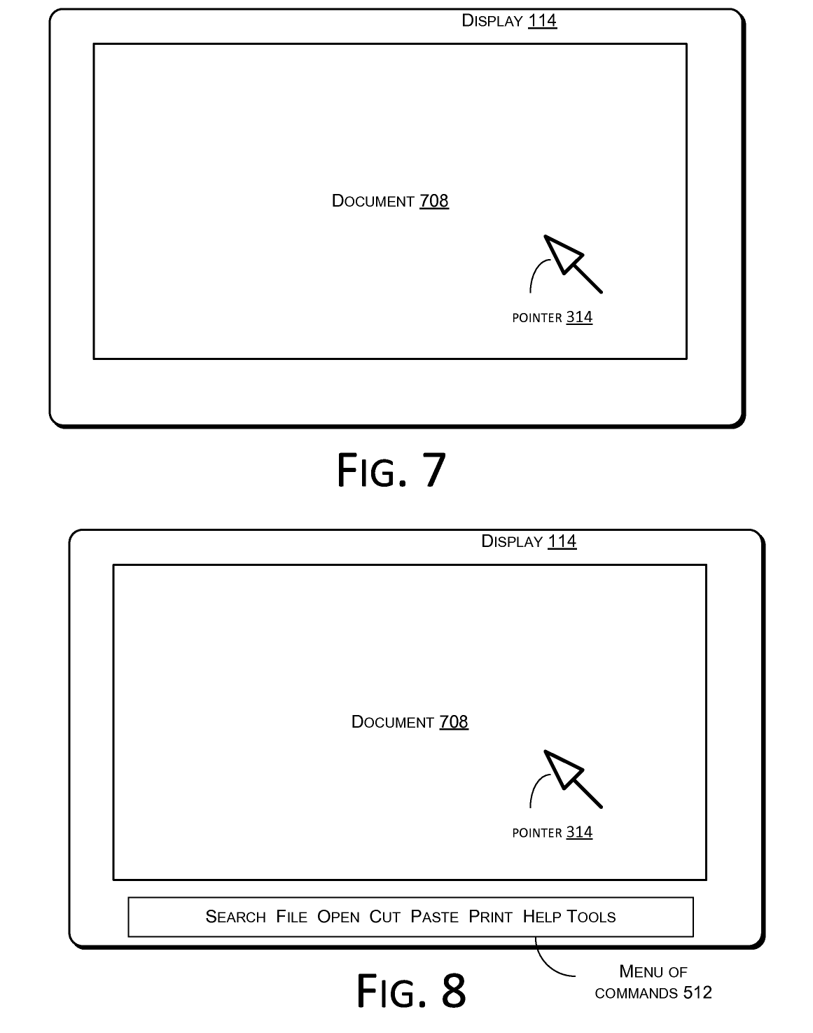

Referring to FIGS. 7 and 8, in accordance with alternative embodiments, an application is being executed within the computing system 100. Various commands and inputs may be needed while the application is being executed. For example, a web browser generally includes various commands for searching and displaying web pages from the Internet on the visual display 114. In accordance with alternative embodiments of the present disclosure, the web browser or other application may display a document 708 on the visual display 114 but without any commands displayed for interacting with the web browser. This can allow for better viewing of web content. If the user wishes to execute a command such as, for example, go back a page, go forward a page, perform a search, etc., then the user moves the pointing device 122 such that the pointer 314 points at the web browser displayed on the visual display 114. A single activation of a first user input on the pointing device 122, i.e., a single click of the right input button 214 causes a menu 712 of commands for the web browser to appear on the visual display 114. The menu 712 of commands can be displayed along the top, the bottom, the side or wherever the user configures the web browser application to display the commands on the visual display 114. When the user is finished using the commands, the user can move the pointing device 122 such that the pointer 314 points at the web browser. Then, with a single activation of the first user input, i.e., the right input button 214 of the pointing device 122, the menu 712 of commands will disappear. Additionally, in accordance with various embodiments, if none of the commands has been used for a predetermined amount of time, then the commands can disappear automatically, i.e., after “timing out.”

In accordance with alternative embodiments, if the user wishes to discontinue use of the web browser, then the user can move the pointing device 122 so that the pointer 314 is not pointing at the web browser displayed on the visual device 114. With a single activation of a second user input, i.e., a single click of the left input button 210, then the web browser will cease being executed.

While the alternative embodiments described with respect to FIGS. 7 and 8 refer to a web browser, other applications can benefit from the alternative embodiments described with respect to FIGS. 7 and 8. The description with respect to a web browser is merely an example and is not meant to be limiting.

In accordance with various other alternative embodiments, the pointing device 122 can be configured so that buttons other than the left and right input buttons 210, 214 are used as the first and second user inputs of the pointing device 122. For example, two buttons 222A, 222B located along a side of the pointing device 122 could serve as the first and second user inputs of the pointing device 122. Additionally, if the pointing device 122 includes a scroll wheel or a roller ball, then depression of either the scroll wheel or the roller ball could serve as the first user input or the second user input of the pointing device 122. Additionally, if the computing system 100 is a portable computer type device that includes a touchpad having inputs similar to a mouse, then the touchpad can be configured to operate as described herein. The alternative embodiments described with respect to the configuration of the pointing device 122 apply to all of the various techniques and arrangements described herein.

### Conclusion

Although the invention has been described in language specific to structural features and/or methodological acts, it is to be understood that the invention is not necessarily limited to the specific features or acts described. Rather, the specific features and acts are disclosed as example forms of implementing the invention.

What is claimed is:

1. A method of handling input from a pointing device within a computing system, the method comprising:
under control of one or more processors configured with executable instructions:
receiving, from the pointing device, a first signal related to a first object representing an application executable within the computing system, wherein the pointing device is causing a pointer to point at the first object on a visual display of the computing system;
determining an origin, with respect to the pointing device, of the first signal; and
based upon the determining the origin of the first signal,
if the first signal originated based upon a single activation of a first user input of the pointing device, selecting the first object; and
if the first signal originated based upon a single activation of a second user input of the pointing device, executing the first object.

2. The method of claim 1, further comprising:
receiving, from the pointing device, a second signal related to a second object representing an application executable within the computing system, wherein the pointing device is causing a pointer to point at the second object on the visual display of the computing system;
determining an origin, with respect to the pointing device, of the second signal; and
based upon the determining an origin of the second signal,
if the second signal originated based upon a single activation of the first user input of the pointing device, selecting the second object; and
if the second signal originated based upon a single activation of the second user input of the pointing device, executing the second object,
wherein if the second object is selected and the first object was selected, the first object remains selected.

3. The method of claim 2, wherein if the second object is executed and the first object was selected, the first object is no longer selected.

4. The method of claim 2, wherein if the second object is executed and the first object was selected, the first object remains selected.

5. The method of claim 1, wherein selecting the first object comprises opening, on the visual display, a menu of commands for execution related to the first object.

6. The method of claim 1, further comprising:
receiving, from the pointing device, a second signal related to the first object, wherein the second signal originates based upon a single activation of the first user input of the pointing device, and wherein the pointing device is causing a pointer to point at the first object on the visual display; and
based upon receiving the second signal, unselecting the first object.

7. The method of claim 1, wherein the pointing device is a mouse comprising a right input button and a left input button, wherein the first user input comprises one of the right input button and the left input button, and wherein the second user input comprises the other of the right input button and the left input button.

8. The method of claim 1, wherein the pointing device is a mouse comprising multiple input buttons and one of a roller ball or a scroll wheel, wherein the first user input comprises one of the multiple input buttons or the one of a roller ball or a scroll wheel, and wherein the second user input comprises a different one of the multiple input buttons or the one of a roller ball or a scroll wheel.

9. One or more computer-readable media configured with computer-executable instructions that, when executed by one or more processors within a computing system, configure the one or more processors to perform acts comprising:
receiving, from a pointing device within the computing system, a first signal related to a first object representing an application executable within the computing system, wherein the pointing device is causing a pointer to point at the first object on a visual display of the computing system;
determining an origin of the first signal; and
based upon the determining an origin of the first signal,
if the first signal originated based upon a single activation of a first user input of the pointing device, selecting the first object; and
if the first signal originated based upon a single activation of a second user input of the pointing device, executing the first object.

10. The one or more computer-readable media of claim 9, wherein the one or more acts further comprise:
receiving, from the pointing device, a second signal related to a second object representing an application executable within the computing system, wherein the pointing device is causing a pointer to point at the second object on the visual display of the computing system;
determining an origin of the second signal; and
based upon the determining an origin of the second signal,
if the second signal originated based upon a single activation of the first user input of the pointing device, selecting the second object; and
if the second signal originated based upon a single activation of the second user input of the pointing device, executing the second object,
wherein if the second object is selected and the first object was selected, the first object remains selected.

11. The one or more computer-readable media of claim 10, wherein if the second object is executed and the first object was selected, the first object is no longer selected.

12. The one or more computer-readable media of claim 10, wherein if the second object is executed and the first object was selected, the first object remains selected.

13. The one or more computer-readable media of claim 9, wherein selecting the first object comprises opening, on the visual display, a menu of commands for execution related to the first object.

14. The one or more computer-readable media of claim 9, wherein the one or more acts further comprise:
receiving a second signal related to the first object, wherein the second signal originates based upon a single activation of the first user input of the pointing device, and wherein the pointing device is causing a pointer to point at the first object on the visual display; and
based upon receiving the second signal, unselecting the first object.

15. A pointing device for use in a computing system, the pointing device comprising:
a controller for controlling the pointing device to move a pointer on a visual display of the computing system based upon movement, by a user, of the pointing device; and
a plurality of user inputs in communication with the controller such that the pointing device communicates signals from the plurality of user inputs to one or more processors within the computing system,
wherein a first user input is configured such that:
if an application is currently operating within the computing system the pointer is pointing at a display of the application on the visual display, a single activation of the first user input causes a user interface for the application to appear on the visual display and a subsequent single activation of the first user input causes the user interface for the application to disappear; and
if the pointer is pointing at a first object on the visual display, where the first object is related to an application executable within the computing system, a single activation of the first user input causes the first object to be selected;
wherein a second user input is configured such that:
if (i) an application is currently operating within the computing system, (ii) the user interface is displayed on the visual display and (iii) the pointer is not pointing at the user interface, a single activation of the second user input causes the application to cease operation; and
if the pointer is pointing at the first object on the visual display, a single activation of the second user input causes the first object to be executed.

16. The pointing device of claim 15, wherein the first user input is further configured such that if an application is currently operating within the computing system and the pointer is pointing at the first object, a single activation of the first user input causes the user interface for the application to appear on the visual display, or to disappear if already displayed, and for the first object to be selected, or to be unselected if already selected.

17. The pointing device of claim 15, wherein the user interface comprises a menu of commands.

18. The pointing device of claim 15, wherein the user interface, if displayed, disappears after a predetermined amount of time has elapsed during which the user has not interacted with the user interface.

19. The pointing device of claim 15, wherein the pointing device is a mouse and the plurality of user inputs comprises a right input button and a left input button, wherein the first user input comprises one of the right input button and the left input button, and wherein the second user input comprises the other of the right input button and the left input button.

20. The pointing device of claim 15, wherein the pointing device is a mouse and the multiple user inputs comprises multiple input buttons and one of a roller ball or a scroll wheel, wherein the first user input comprises one of the multiple input buttons or the one of a roller ball or a scroll wheel, and wherein the second user input comprises a different one of the multiple input buttons or the one of a roller ball or a scroll wheel.
